(19) United States
(12) Patent Application Publication
(10) Pub. No.: US 2012/0312273 A1
(43) Pub. Date: Dec. 13, 2012

(54) INTERNAL COMBUSTION ENGINE WITH TORSIONAL ELEMENT

(75) Inventor: Robert T. Weverka, Boulder, CO (US)

(73) Assignee: Robert T. Weverka, Boulder, CO (US)

(21) Appl. No.: 13/158,058

(22) Filed: Jun. 10, 2011

(51) Int. Cl. F02B 75/32

(52) U.S. Cl. 123/197.3

(57) ABSTRACT

An internal combustion engine has a cylinder and a piston disposed with the cylinder to define a combustion chamber that is bounded at least in part by interior surfaces of the cylinder and a surface of the piston. A mechanism coupled with the piston reciprocates the piston within the cylinder, causing the combustion chamber to have a volume that varies in accordance with motion of the piston. A torsional element is coupled with the mechanism such that mechanical energy is stored in and released from the torsional element with motion of the piston.

### BACKGROUND OF THE INVENTION

This application relates generally to internal combustion engines. More specifically, this application relates to an internal combustion engine that includes a torsional element.

The internal combustion engine has a long history and became widely adopted in a variety of applications in the late 19th century, persisting in its ubiquitous presence in the 20th and 21st centuries. It is most commonly used to provide mobile propulsion in motor vehicles, including automobiles, trucks, motorcycles, boats, and a wide variety of aircraft and locomotives. This long history is reflected in the various efforts that have been made to improve the efficiency of the engine, particularly by limiting energy losses in the form of heat.

As used herein, an “internal combustion engine” refers to any engine in which a fuel is combusted with a combustor in a chamber to produce an expansion of gases that results in the generation of a force on a component of the engine. Typically, the combustor comprises an oxidizer like air and the fuel comprises a fossil fuel like diesel, gasoline, petroleum gas, or propane, although the general principles of operation of the internal combustion engine are the same regardless of the specific fuel and combustor that are used. There are, moreover, a wide variety of designs for the internal combustion engine that include reciprocating engines in which pistons move within cylinders to convert pressure into rotational motion. Examples of reciprocating engines particularly include stroke engines, with known designs implementing two-stroke cycles, four-stroke cycles, and six-stroke cycles, although other implementations of stroke engines are also known. Other structures for internal combustion engines avoid the use of pistons, such as by using rotors to effect the conversion of pressure resulting from combustion of the fuel into rotational motion instead of into reciprocating piston motion. Both reciprocating engines and rotary engines are examples of engines that operate with intermittent combustion. Other designs use the same general principle of converting pressure into rotation motion, but are configured so that the combustion is substantially continuous.

By way of example, FIGS. 1A-1D illustrate the operation of a conventional four-stroke spark-ignition reciprocating internal combustion engine, with each of the separate drawings highlighting one of four principal stroke portions of a cycle defined by two rotations of a crankshaft. Within the engine, each of a plurality of cylinders may have a structure like that illustrated in any of FIGS. 1A-1D. The combustion chamber 128 is defined by a body 100 of the cylinder and a piston 116, with the size of the combustion chamber 128 being dependent on a position of the piston 116. This variation in the combustion chamber is noted in the drawings by identifying it with reference numbers 128, 128′, 128″, or 128′″ depending on the specific position of the piston 116 at particular times. Ingress of a fuel/air mixture into the combustion chamber 128 is controlled with an intake valve denoted by reference number 108 when in an open position and by reference number 108′ when in a closed position. Similarly, egress of exhaust gases from the combustion chamber 128 is controlled with an exhaust valve denoted by reference number 112 when in an open position and by reference number 112′ when in a closed position. The position of the piston 116 is controlled by a crankshaft 118, whose rotational motion is converted into linear motion of the piston 116 via coupling to the piston 116 through a crankshaft arm 120 and connecting rod 124 that are coupled via a crankpin 122. The crankpin is offset from an axis of rotation of the crankshaft. A spark plug 104 provides a spark within the combustion chamber 128 at the appropriate time to ignite the fuel/air mixture.

FIG. 1A shows a configuration of the cylinder during an intake stroke: The piston 116 is moving downwards and the intake valve 108 is open so that the fuel/air mixture is drawn into the combustion chamber 128. Near the time when the piston 116 reaches its position closest to the crankshaft axis, referred to as the “bottom dead center” position, the intake valve 108 closes so the subsequent motion of the piston 116 as the crankshaft 118 rotates acts to decrease the volume of the combustion chamber 128′ and thereby compress the fuel/air mixture. This is illustrated generally in FIG. 1B and corresponds to the compression stroke. Near the time when the piston 116 reaches its position farthest from the crankshaft axis, referred to as the “top dead center” position, the spark plug 104 fires to ignite the compressed fuel/air mixture. The resulting pressure forces the piston 116 down during the power stroke as illustrated in FIG. 1C. The exhaust stroke begins once the piston 116 again reaches the bottom dead center position and the exhaust valve is opened near this point to release the exhaust-gas byproducts of the fuel/air ignition. The gas is exhausted by the subsequent motion of the piston 116 back to the top dead center position, at which point the cycle may repeat as the piston 116 moves downwards and the intake valve is reopened.

While other designs of internal combustion engines vary in a number of details, they all operate according the general principle of igniting a fuel/combustor mixture within a chamber to produce gas expansion.

### SUMMARY

Embodiments of the invention are directed to an internal combustion engine that comprises a cylinder and a piston disposed with the cylinder to define a combustion chamber that is bounded at least in part by interior surfaces of the cylinder and a surface of the piston. A mechanism coupled with the piston is adapted to reciprocate the piston within the cylinder, causing the combustion chamber to have a volume that varies in accordance with motion of the piston. A torsional element is coupled with the mechanism such that mechanical energy is stored in and released from the torsional element with motion of the piston.

In some of these embodiments, the mechanism comprises a crankshaft with a crankpin offset from an axis of rotation of the crankshaft such that the crankpin revolves about the axis of rotation. The torsional element in such embodiments may comprise a flexible crankshaft arm connecting the axis of rotation of the crankshaft to the crankpin. In some instances, the mechanism also comprises a stop disposed to prevent revolution of the crankpin beyond a predetermined revolution limit.

In other embodiments, the mechanism comprises a substantially rigid crankshaft arm connecting the axis of rotation of the crankshaft to the crankpin and the torsional element couples the substantially rigid crankshaft arm to the stop. In embodiments that include a stop, the stop may comprise a plurality of stops, each of the plurality of stops being disposed to prevent revolution of the crankpin beyond a respective predetermined rotation limit.

In a specific embodiment, the cylinder comprises a plurality of cylinders and the piston comprises a plurality of pistons. Each of the pistons is disposed within a respective one of the plurality of cylinders to define respective combustion chambers. The mechanism comprises a crankshaft with a plurality of crankpins, each of the crankpins being coupled to a respective one of the plurality of pistons and offset from an axis of rotation of the crankshaft such that the each of the crankpins revolves about the axis of rotation of the crankshaft. The torsional element couples the crankshaft to a drive output of the engine.

In different embodiments, the torsional element comprises a torsion spring. Furthermore, the internal combustion engine may comprise a variety of different structures in different embodiments, including a spark ignition engine, a compression ignition engine, a direct injection engine, an extended power stroke engine, and a variable compression engine, among others.

Other embodiments of the invention are directed to methods of generating power. A piston is reciprocated within a cylinder to define a combustion chamber having a volume that varies in accordance with motion of the piston. Combustion fluids are flowed into the combustion chamber during an intake stroke. The combustion fluids are compressed within the combustion chamber during a compression stroke in accordance with the motion of the piston. The compressed combustion fluids ignite or are ignited within the combustion chamber during or a little before the beginning of a power stroke. Mechanical energy resulting from pressure by the ignited combustion fluids on the piston are stored in a torsional element. Thereafter, the stored mechanical energy is released from the torsional element.

Storing the mechanical energy in the torsional element may result in nonsinusoidal motion of the piston. In some instances, reciprocating the piston within the cylinder comprises revolving a crankpin that couples the piston with a crankshaft about an axis of rotation of the crankshaft, with revolution of the crankpin beyond a predetermined revolution limit being prevented.

In another method of generating power, a piston is reciprocated within a cylinder to define a combustion chamber having a volume that varies in accordance with motion of the piston, with the motion of the piston being nonsinusoidal. Combustion fluids are flowed into the combustion chamber substantially during an intake stroke. The combustion fluids are compressed within the combustion chamber during a compression stroke in accordance with the motion of the piston. The compressed combustion fluids ignite or are ignited within the combustion chamber during or a little before the beginning of a power stroke. A portion of energy resulting from pressure by the ignited combustion fluids on the piston is stored and thereafter transferred to an output.

### BRIEF DESCRIPTION OF THE DRAWINGS

A further understanding of the nature and advantages of the present invention may be realized by reference to the remaining portions of the specification and the drawings.

FIGS. 1A-1D provide illustrations of a conventional prior-art four-stroke reciprocating internal combustion engine respectively during the four phases of intake, compression, power, and exhaust;

FIG. 2 is a flow diagram broadly summarizing the use of a torsional element with an internal combustion engine in accordance with embodiments of the invention;

FIGS. 3A-3D provide an illustration of an embodiment in which the torsional element is embodied by the crankshaft arm of a four-stroke reciprocating internal combustion engine;

FIGS. 4A and 4B provide an illustration of an embodiment in which the torsional element is embodied through coupling the crankshaft arm with the main shaft of the crankshaft;

FIG. 5 provides an illustration of an embodiment in which the torsional element is embodied through coupling of the crankshaft with a flywheel;

FIG. 6 is a graph illustrating the effect of the presence of the torsional element on piston height for the embodiment of FIG. 5; and

FIG. 7 is a graph illustrating the variation in torque as a function of crank angle for different throttle and flywheel configurations, illustrating the effect of including a torsional element in the engine structure.

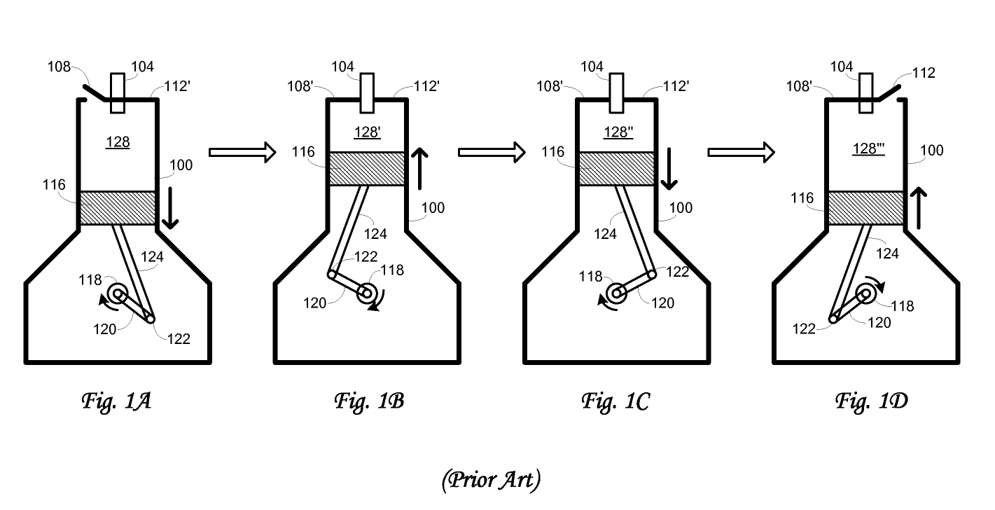

### DETAILED DESCRIPTION OF EXEMPLARY EMBODIMENTS

Embodiments of the invention include a torsional element in the structure of an internal combustion engine to provide more rapid expansion of the combustion chamber when compared with a conventional internal combustion engine, and to provide a low-loss transfer of the peak energy in the combustion fluids to stored mechanical energy that can do work on the output.

As used herein, a “torsional element” is a flexible object that stores mechanical energy when twisted, either elastically or inelastically. One example of a torsional element that may used with embodiments of the invention is a torsion spring, which is a helical rod or wire that stores mechanical energy when twisted about the coil axis by the application of bending moments to its ends, i.e. to twist the coil more tightly. The helical rod or wire may comprise a metal or other material in different embodiments. The invention is not limited to the use of a torsion spring and may use substitute or equivalent alternative torsional elements in different embodiments. For example, some embodiments may use a torsion bar that stores mechanical energy when twisted about its axis by the application of torque at its ends Other elements known to those of skill in the art that store mechanical energy when twisted may be used in other alternative embodiments.

To understand the effect of including a torsional element in the structure of an internal combustion engine, approaches that have previously used to improve the efficiency of such engines are described. It is noted that, in some embodiments, such approaches may still be used in combination with including a torsional element as taught herein.

Regardless of the specific design of an internal combustion engine, whether it be the four-stroke reciprocating engine described above or another known design, most of the fuel energy provided to the engine is lost to hot exhaust gases and to heating the combustion-chamber walls and cooling system. One class of approaches to improving engine efficiency has accordingly focused on these losses and attempted to reduce them. While some success has been achieved in limiting loss and recovering energy in the exhaust gas, attempts to preserve the energy lost to the combustion chamber walls have so far met with only limited success.

For example, some engine designs, notably the Miller and Atkinson cycle designs, use an extended power stroke that captures more of the energy in the expanding gases that would otherwise be lost to exhaust heat. Turbocharged engines recover some of the energy in the exhaust gases and use it to compress the intake charge. These techniques of recovering energy from exhaust are compatible with, and often synergistic to, techniques to limit losses to the combustion-chamber walls. But the extended-stroke power designs require a larger engine to accommodate the extra expansion. Thus, while they provide more energy for a given amount of fuel, they have less power for a given engine size, i.e. they have a reduced volumetric efficiency.

The reduced volumetric efficiency of an extended power-stroke engine requires a heavier engine to produce sufficient power, or requires an auxiliary power supply such as is commonly provided in a hybrid automobile. This shortcoming can be alleviated with a dual-mode engine, which has one mode in which the intake charge is limited to a fraction of the cylinder volume and the power-stroke is much larger than the compression. A number of techniques have been proposed to provide a variable-compression engine, which allow the extended power stroke for high efficiency when less power is required and allow a larger fuel charge when more power is required.

Direct injection in conjunction with lean burn may eliminate the need for a variable compression. Combined with variable intake-valve opening, an engine can compress the air much more without preignition. Higher compression leads to greater efficiency and more heat in the combustion products. Notably, such a higher temperature system can derive even greater benefits from the low heat-rejection techniques enabled by the invention.

Alternative approaches to improve efficiency by reducing losses to the engine coolant typically involve insulating the combustion chamber, but the improvements from such approaches have been modest. Insulating the engine reduces the volumetric efficiency and requires the use of materials and lubricants capable of functioning at high temperatures. The methods and systems of the invention advantageously allow for rapid expansion of the combustion chamber to reduce the temperature in the combustion fluids and consequent loss of heat to the engine coolant.

The general effects of including a torsional element in the structure of an internal combustion engine as described herein may be understood by noting that the peak pressure and temperature inside an internal combustion engine occur near the top dead center position. Typical internal combustion engines dissipate about a third of their energy as heat deposited in the walls of the combustion chamber. This heat is removed by fluid cooling, usually by air or water cooling. This energy transfer cools the gases in the chamber during the power stroke, reducing the pressure and hence the force on and work done by the piston. When the crankshaft rotates with constant angular velocity, rigidly coupled pistons move up and down sinusoidally in time, giving the system a large dwell time when the combustion chamber is near its smallest volume and the combustion fluids are hottest. It is during this dwell that a significant portion of the energy in the combustion fluids is transferred to the combustion chamber walls in the form of heat. The inclusion of a torsional element allows a rapid expansion of the combustion chamber, producing at least two effects. First, the increase in volume reduces the temperature, and therefore also the heat flow rate into the combustion chamber walls. Second, the expanded volume combustion chamber has a significantly higher volume-to-surface-area ratio, further reducing the energy flow into the chamber walls.

The inclusion of a torsional element provides for rapid expansion of the combustion chamber without changing the compression ratio. Force built up on the piston rod as a consequence of combustion is transferred cosinusoidally to torque on the crankshaft. This torque acts to store energy within the torsional element, such as by tightening a torsion spring in embodiments where the torsion element comprises a torsion spring, and also pushes on the engine output. As the output turns and the combustion chamber expands towards its maximal volume, the torsional element returns the stored energy back to the engine output.

It is noted that the torsional element need not be preloaded. This is in marked contrast to alternative approaches that have proposed the use of linear springs on the piston rod, such as described in U.S. Pat. Nos. 2,372,472, 4,111,164, and 7,318,397, the entire disclosure of each of which is incorporated herein by reference for all purposes. These references describe a spring-piston or connecting rod system for achieving variable compression in the cylinder. Such springs compress to store energy upon expansion of the combustion chamber and store energy in the spring. For example, U.S. Pat. No. 7,318,397 describes conversion of energy in the initial peak pressure into stored energy in the linear spring, which is released later in the power stroke. Such systems suffer from the requirement that the spring be compressed during the compression stroke, with this preloading of the spring increasing the back pressure and reducing the speed at which the combustion chamber may expand. Such systems consequently have a longer dwell at high pressure, high temperature, and low volume, making them transfer more heat the cylinder walls. At low power, the precompressed spring undergoes little further compression so that such a technique does not reduce the loss to the cylinder walls. Furthermore, such linear-spring deployments may compress during the compression stroke, thereby limiting the compression of the intake charge.

In contrast, the use of a torsional element that is not preloaded gives the system compliance sufficient to allow the engine under modest load to quickly increase the combustion-chamber volume. The torsional element may be fully relaxed at the top dead center position, allowing it more quickly to compress under the force of the combustion fluids in the combustion chamber. Because the piston rises to full height with the torsional element regardless of backpressure, the torsional element can accommodate the high compression ratio used in compression ignition and direct-injection engines.

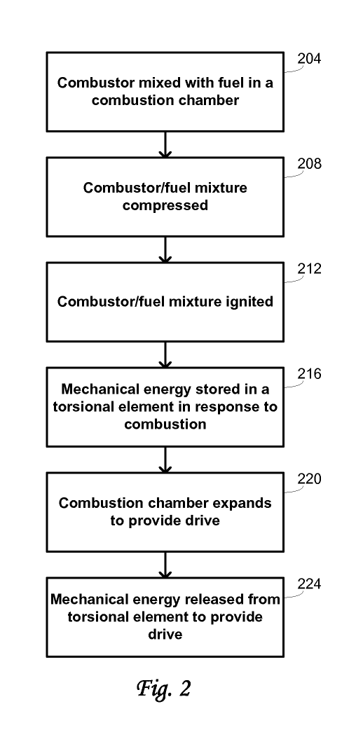

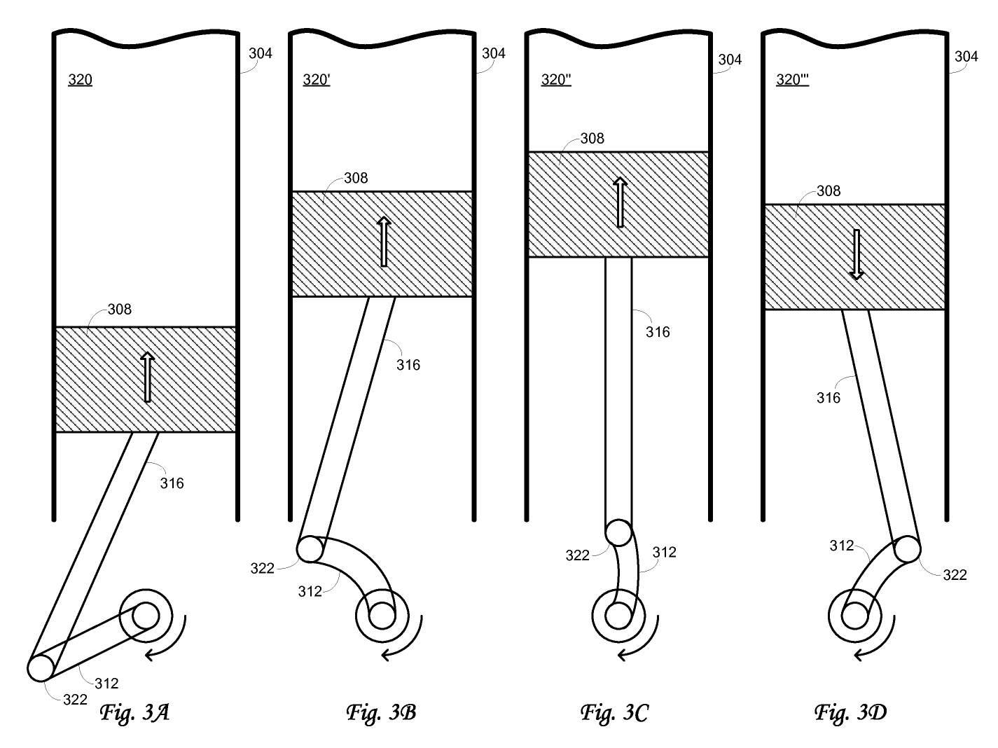

A general overview of the invention is provided with the flow diagram of FIG. 2, which summarizes a number of different embodiments that are described structurally and more specifically below. The methods outlined by the flow diagram of FIG. 2 correspond to methods of generating power with an internal combustion engine, with the method beginning at block 204 by mixing a combustor with fuel in a combustion chamber. The combustor may comprise an oxidizer like air and the fuel may comprise a fossil fuel like diesel, gasoline, petroleum gas, or propane, although different combustors and fuels may be used in different embodiments provided that the mixture is ignitable. At block 208, the combustor/fuel mixture is compressed as prelude to its ignition at block 212. The ignition in the combustion chamber results in the reaction conversion of chemical energy stored by the fuel to have at least two effects: the storage of mechanical energy in a torsional element at block 216 and expansion of the combustion chamber at block 220. The expansion of the combustion chamber provides drive that may be used for propulsion of a vehicle or for other purposes, similar to the operation of a conventional internal combustion engine. The mechanical energy stored in the torsional element may also provide drive when it is released at block 224 in response to the expansion of the combustion chamber.

There are a number of different ways in which the torsional element may be configured to be a part of the internal combustion engine. The invention is not limited to the specific configurations described below, which are provided for exemplary purposes and to illustrate that there are a variety of ways in which the torsional element may be disposed in different embodiments. Furthermore, there are numerous variations on the structure of internal combustion engines, and as will be evident to those of skill in the art after reading this disclosure, the general principle of the invention is broadly applicable to any structural design in which fuel combustion in a chamber is used to produce an expansion of gases to generate drive.

FIGS. 3A-3D provide one illustration in which the torsional element is comprised by a flexible crankshaft arm, with the spring force in the torsional system deriving from the bending moment of the arm. This illustration is provided in the context of a four-stroke reciprocating engine, but the use of a flexible structure to provide a bending moment may be used in other configurations also. The operation of the engine is similar to operation of a prior-art engine, with the additional torsional element.

Each cylinder 304 contains a piston 308 that is translated within the cylinder by a combination of a crankshaft arm 312 and connecting rod 316 that are coupled by a crankpin 322. The crankpin is offset from an axis of rotation of the crankshaft. A combustion chamber has a variable size defined by a position of the piston 308 and is denoted by reference numbers 320, 320′, 320″, or 320′″ respectively in FIGS. 3A-3D according to different positions of the piston 308. FIGS. 3A and 3B show not only how the position of the elements changes during progression of the compression stroke, but also how the crankshaft arm 312 bends during that stroke. When the piston 308 approaches the top dead center position as shown in FIG. 3C, the crankshaft arm begins to release and bends in the opposite direction at the beginning of the power stroke as shown in FIG. 3D. This shift in bending direction at top dead center occurs in response to pressure in the cylinder 304 and enables the rapid expansion of the combustion chamber after ignition of the compressed fuel/air mixture and effects the storage of mechanical energy in the torsional element as described in connection with FIG. 2.

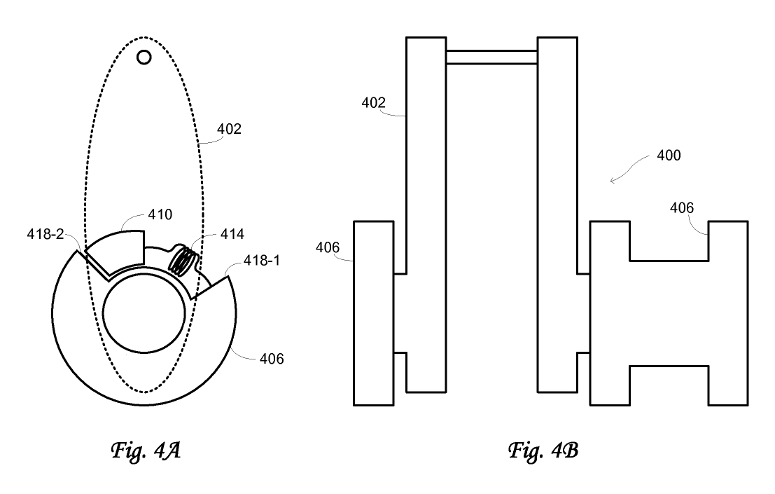

In other embodiments, the crankshaft arm may be provided as a rigid structure, with the torsional element included elsewhere within the system. One illustration of such an embodiment is provided with FIGS. 4A and 4B, which respectively show end and side views of a crankshaft 400. The crankshaft 400 comprises a main shaft 406 and a crankshaft arm 402 that is generally rigid and free to move within limits defined by a structure of the main shaft 406. In this instance, such limited motion is defined by a structure of the main shaft 406 best seen in the end view of FIG. 4A. The main shaft 406 has a generally circular cross section with an open portion that defines limit stops 418-1 and 418-2. These limit stops 418 may be engaged by a key 410 comprised by the crankshaft arm 402 so that motion of the crankshaft arm 402 is generally delimited by the constrained range of motion of the key 410.

The torsional element in this embodiment comprises a torsion spring 414 coupled at one end to one of the limit stops 418-1 of the main shaft 406 and coupled at another end to the key 410. The result of this configuration is that motion of the crankshaft arm during the different engine strokes stores mechanical energy in the torsional element 414 and provides for rapid expansion of the combustion chamber as described above.

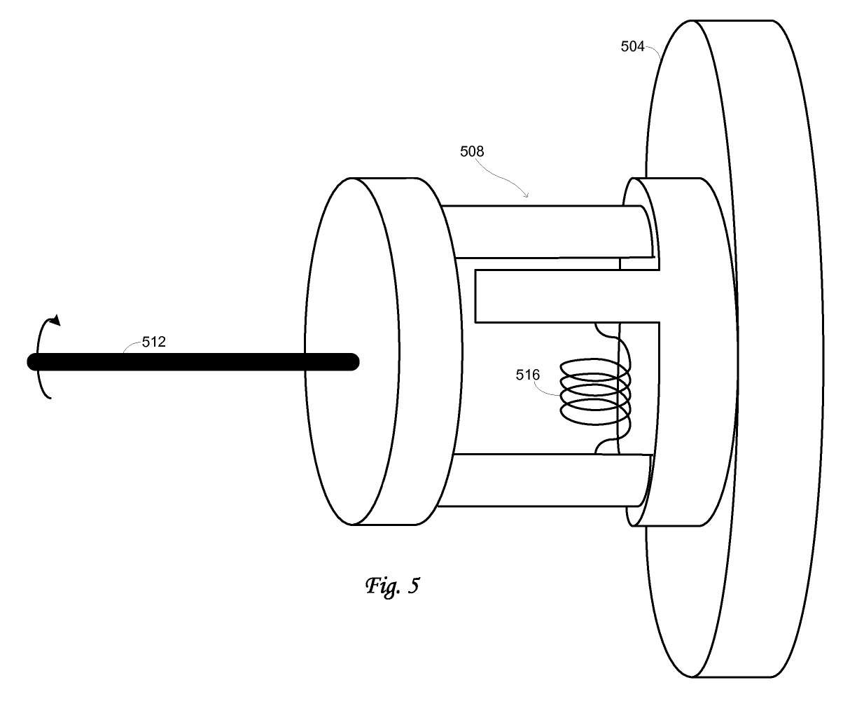

In yet another embodiment illustrated in FIG. 5, the same principle is used to provide the torsional element in a different position within the engine structure. The crankshaft 508 is provided with limit stops that engage with a flywheel 504, with motion of the crankshaft communicated through arm 512. The torsional element is again provided as a torsion spring 516 with one end coupled to a limit stop defined by the flywheel 504 and another end coupled to a limit stop defined by the crankshaft. The result of this configuration is similar to those described above: as each cylinder proceeds through the different strokes, mechanical energy is stored in the torsional element 516 and rapid expansion of the combustion chamber results after ignition of the compressed fuel/air mixture.

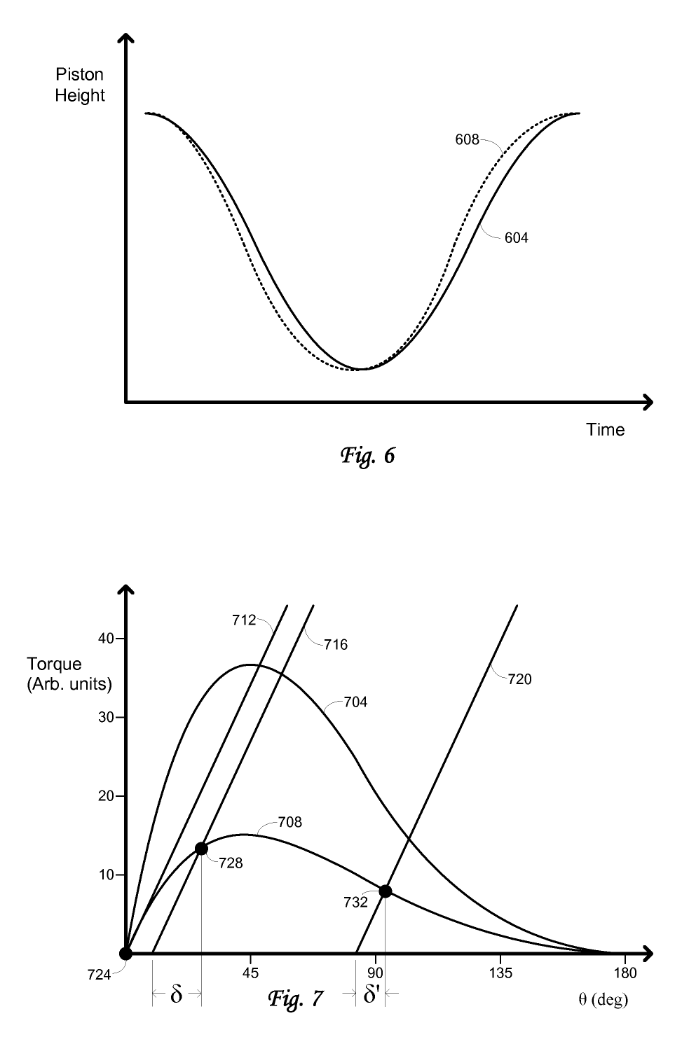

A general illustration of how the inclusion of a torsional element according to embodiments of the invention affects the expansion of the combustion chamber is illustrated schematically with FIG. 6, which provides a plot of piston height as a function of time for a full cycle of a reciprocating internal combustion engine having a rigid crankshaft. The solid line 604 shows how the piston height varies with a prior-art construction that lacks a torsional element, showing the familiar sinusoidal motion of the piston as the rotational motion of the crankshaft is converted to translational motion of the piston through the crankshaft arm and connecting rod. The dashed line 608 illustrates how the time dependence of the piston height changes as a result of including a torsional element in the structure, with the piston dropping more rapidly from the top dead center position than in a conventional engine.

The drawing of FIG. 6 is generic. While specific details of the piston-height variation may differ in different embodiments, the drawing is illustrative of the effect of including the torsional element according to the various foregoing embodiments. For example, the drawing can be considered in the context of the embodiment described in connection with FIGS. 3A-3D as showing a comparison of the sinusoidal piston-height variation for a rigid crankshaft arm as compared with the nonsinusoidal variation for a flexible crankshaft arm. The degree to which the variation is away from sinusoidal for the flexible crankshaft arm is, of course, dependent on the elasticity of the material used for the crankshaft arm.

The drawing may also be considered in the context of the embodiment described in connection with FIGS. 4A and 4B as showing a comparison of the sinusoidal piston-height variation for a conventional engine with the variation that results from inclusion of the torsional element. In this instance, the degree of variation from sinusoidal may be dependent on such factors as the torsion coefficient of the torsion spring.

Similarly, the drawing may be considered in the context of the embodiment described in connection with FIG. 5. In that instance the sinusoidal variation 604 corresponds to the behavior of the piston when the crankshaft is rigidly coupled with the flywheel, with the effect of having the coupling be via a torsion spring resulting in the nonsinusoidal variation 608. Again, the degree of variation from sinusoidal may be dependent on such factors as the torsion coefficient of the torsion spring.

FIG. 7 provides a further graphical illustration of the effect of including a torsion element in the structure of an internal combustion engine. Curves 704 and 708 show how the torque generated by a particular cylinder varies as a function of the crank angle θ under different throttle conditions. The crank angle θ is defined as the angle of revolution of the crankshaft arm from the point where the piston is situated at the top dead center position. The torque is shown for each curve for a single period of revolution and repeats the same behavior as the crankshaft arm continues to revolve about the crankshaft axis. Curve 704 shows the dependence of the torque on crank angle θ when the throttle is completely open while curve 708 shows how the curve is modified when the throttle is partially open. The curves 704 and 708 have similar shapes, with the greatest torque being achieved when the throttle is fully open.

Overlaid on these curves are examples of torque curves for torsional elements that follow Hooke's Law. It is to be understood that some torsional elements may show deviations from Hooke's Law so that such torque curves are nonlinear, but the same principles apply with such nonlinear curves. Thus, lines 712, 716, and 720 correspond to torque curves for three different flywheel positions. In the static analysis, the crankshaft arm rotates until the torques balance, i.e. where the lines cross as indicated by dots 724, 728, and 732 for the three flywheel positions when the throttle is partially open. The advance of the crankshaft arm over a conventional internal combustion engine is the horizontal displacement of this crossing, i.e. corresponding to 0, δ, and δ′ for the three flywheel positions.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. An internal combustion engine comprising:
a cylinder;
a piston disposed within the cylinder to define a combustion chamber bounded at least in part by interior surfaces of the cylinder and a surface of the piston;
a mechanism coupled with the piston and adapted to reciprocate the piston within the cylinder, whereby the combustion chamber has a volume that varies in accordance with motion of the piston; and
a torsional element coupled with the mechanism such that mechanical energy is stored in and released from the torsional element with motion of the piston.

2. The internal combustion engine recited in claim 1 wherein the mechanism comprises a crankshaft with a crankpin offset from an axis of rotation of the crankshaft such that the crankpin revolves about the axis of rotation.

3. The internal combustion engine recited in claim 2 wherein the torsional element comprises a flexible crankshaft arm connecting the axis of rotation of the crankshaft to the crankpin.

4. The internal combustion engine recited in claim 3 wherein the mechanism comprises a stop disposed to prevent revolution of the crankpin beyond a predetermined revolution limit.

5. The internal combustion engine recited in claim 2 wherein the mechanism comprises a stop disposed to prevent revolution of the crankpin beyond a predetermined rotation limit.

6. The internal combustion engine recited in claim 5 wherein:
the mechanism comprises a substantially rigid crankshaft arm connecting the axis of rotation of the crankshaft to the crankpin; and
the torsional element couples the substantially rigid crankshaft arm to the stop.

7. The internal combustion engine recited in claim 4 wherein the stop comprises a plurality of stops, each of the plurality of stops disposed to prevent revolution of the crankpin beyond a respective predetermined rotation limit.

8. The internal combustion engine recited in claim 1 wherein:
the cylinder comprises a plurality of cylinders;
the piston comprises a plurality of pistons, each of the pistons disposed within a respective one of the plurality of cylinders to define respective combustion chambers;
the mechanism comprises a crankshaft with a plurality of crankpins, each of the crankpins being coupled to a respective one of the plurality of pistons and offset from an axis of rotation of the crankshaft such that the each of the crankpins revolves about the axis of rotation of the crankshaft; and
the torsional element couples the crankshaft to a drive output of the engine.

9. The internal combustion engine recited in claim 8 wherein the mechanism further comprises a stop disposed to prevent revolution of the crankpin beyond a predetermined rotation limit.

10. The internal combustion engine recited in claim 1 wherein the torsional element comprises a torsion spring.

11. The internal combustion engine recited in claim 1 wherein the internal combustion engine comprises a spark ignition engine.

12. The internal combustion engine recited in claim 1 wherein the internal combustion engine comprises a compression ignition engine.

13. The internal combustion engine recited in claim 1 wherein the internal combustion engine comprises a direct injection engine.

14. The internal combustion engine recited in claim 1 wherein the internal combustion engine comprises an extended power stroke engine.

15. The internal combustion engine recited in claim 1 wherein the internal combustion engine comprises a variable compression engine.

16. A method of generating power, the method comprising:
reciprocating a piston within a cylinder to define a combustion chamber having a volume that varies in accordance with motion of the piston;
flowing combustion fluids into the combustion chamber during an intake stroke;
compressing the combustion fluids within the combustion chamber during a compression stroke in accordance with the motion of the piston;
igniting the compressed combustion fluids within the combustion chamber during a power stroke;
storing mechanical energy resulting from pressure by the ignited combustion fluids on the piston in a torsional element; and
thereafter releasing the stored mechanical energy from the torsional element.

17. The method recited in claim 16 wherein storing mechanical energy in the torsional element results in nonsinusoidal motion of the piston.

18. The method recited in claim 16 wherein reciprocating the piston within the cylinder comprises revolving a crankpin that couples the piston with a crankshaft about an axis of rotation of the crankshaft, the method further comprising preventing revolution of the crankpin beyond a predetermined revolution limit.

19. The method recited in claim 16 wherein the torsional element comprises a torsion spring.

20. A method of generating power, the method comprising:
reciprocating a piston within a cylinder to define a combustion chamber having a volume that varies in accordance with motion of the piston, wherein the motion of the piston is nonsinusoidal;
flowing combustion fluids into the combustion chamber during an intake stroke;
compressing the combustion fluids within the combustion chamber during a compression stroke in accordance with the motion of the piston;
igniting the compressed combustion fluids within the combustion chamber during a power stroke;
storing a portion of energy resulting from pressure by the ignited combustion fluids on the piston; and
thereafter transferring the stored portion of energy to an output.
